(19) United States
(12) Patent Application Publication
(10) Pub. No.: US 2018/0058648 A1
(43) Pub. Date: Mar. 1, 2018

(54) LED CANDLE WITH EXTERNAL LIGHTING BEING CARRIED ON A SURFACE THEREOF

(71) Applicant: JIAN FANG, SHENZHEN (CN)

(72) Inventor: JIAN FANG, SHENZHEN (CN)

(21) Appl. No.: 15/620,875

(22) Filed: Jun. 13, 2017

(30) Foreign Application Priority Data
Aug. 31, 2016 (CN) 201610797483.1

(51) Int. Cl. F21S 4/10; F21S 6/00; F21S 9/02

(52) U.S. Cl. CPC F21S 4/10; F21Y 2115/10; F21S 9/02; F21S 6/001

(57) ABSTRACT

The present invention relates to a field of LED candles, especially to a LED candle with external lighting being carried on a surface of the LED candle. The LED candle comprises a LED candle body, the LED candle body has a candle shell, a light source situated inside of the candle shell, a power supply electrically connected to the light source, and an illuminant carried on a surface of the candle shell, the illuminant is electrically connected to the power source. The present invention increases the number of the illuminants on the surface of the candle shell to ensure entire of the surface of LED candle exposed under the lighting, and the illuminants may be set in multiple patterns and colors, producing good decoration effect.

### CROSS-REFERENCE TO RELATED APPLICATIONS

This application claims priority to Chinese Patent Application No. 201610797483.1 with a filing date of Aug. 31, 2016. The content of the aforementioned applications, including any intervening amendments thereto, are incorporated herein by reference.

### TECHNICAL FIELD

The present invention relates to a field of LED candles, especially to a LED candle with external lighting being carried on a surface of the LED candle.

### BACKGROUND OF THE PRESENT INVENTION

In the field of LED candles, it used to emphasis emulation of the flame part of the LED candle, therefore, for the conventional LED candles, LED lamp is carried on top of the LED candle, controlling the circuit current may enable the LED lamp to flesh on and off. The advantage is that it looks like a real flame seen from a distance, with a high emulation degree. The disadvantage is that it has a fuzzy contour of the LED candle, with a faint surface, failing to see the surface effect clearly, it has neither illumination effect nor decoration effect, thus reducing the candle's ornamental, as well as can't satisfy the consumer's requirements.

A LED candle is in urgent need that has both high illumination effect at night and good decoration effect.

### SUMMARY OF PRESENT INVENTION

The present invention discloses a LED candle with external lighting being carried on a surface of the LED candle, having both high illumination effect at night and good decoration effect.

The present invention realizes the above aim by the following technique schemes:

A LED candle with external lighting being carried on a surface of the LED candle includes: a LED candle body; the LED candle body has a candle shell, a light source situated inside of the candle shell, a power supply electrically connected to the light source, an illuminant carried on a surface of the candle shell, the illuminant is electrically connected to the power source.

In which, the illuminant is carried on an exterior surface and/or interior surface of the candle shell.

In which, the illuminant is a string of lamps that wind the exterior surface of the candle shell around.

In which, the string of lamps form a rising helix structure to wind the exterior surface of the candle shell around. A helix angle of the string of lamps is gradually increasing from down to up.

In which, the surface of the candle shell has multiple holes, the illuminant includes multiple LED lamp caps, each of the multiple holes is shaped and dimensioned to receive a LED lamp cap.

In which, the hole is a dent, shape of the dent and that of a mounting portion of the LED lamp cap are matched.

In which, the surface of the candle shell has multiple through holes, each through hole is filled with a transparent material. The illuminant includes multiple LED lamp caps that are carried on the interior surface of the transparent materials.

In which, the transparent material is a paraffin layer or a transparent glass;

In which, the power supply is an external power supply, a dry battery or a storage battery.

In which, the candle shell is Christmas tree-shaped, cylinder-shaped, spherical or columnar.

The beneficial effect of the present invention is that the LED candle with external lighting being carried on the surface of the LED candle includes a LED candle body, the LED candle body includes a candle shell, a light source situated inside of the candle shell, a power supply electrically connected to the light source, an illuminant carried on a surface of the candle shell, the illuminant is electrically connected to the power source. Increasing the number of the illuminants on the surface of the candle shell ensures entire of the surface of LED candle exposed under the lighting, the electricity ensures the brightness of lighting from the LED candle even at night. Meanwhile, the illuminants may be set in multiple patterns and colors, producing good decoration effect.

### DESCRIPTION OF THE DRAWINGS

FIG. 1 is a structural diagram of the embodiment 1 of the present invention;

FIG. 2 is a structural diagram of the embodiment 2 of the present invention;

FIG. 3 is a structural diagram of the embodiment 2 of the present invention in another way;

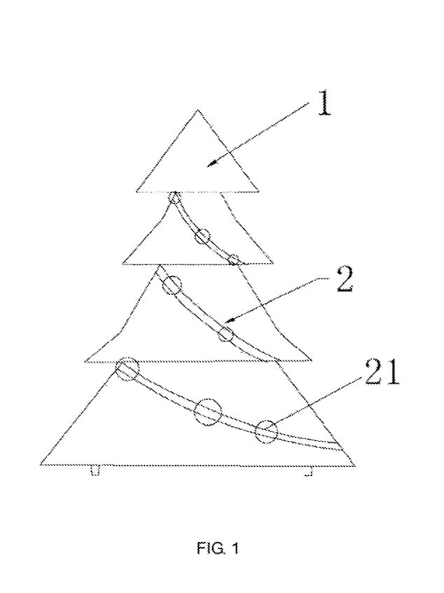

From FIG. 1 to FIG. 3, the present invention includes:

1—the candle shell; 2—the illuminant; 3—the LED lamp caps;

Objective achieving, function features, and advantages of the present invention are further described with reference to the embodiments and the accompany drawings.

### DETAILED DESCRIPTION OF PREFERRED EMBODIMENTS

It should be understood that the specific embodiments described herein are merely used for describing the present invention, but are not intended to limit the present invention.

### Embodiment 1

As shown in FIG. 1, a LED candle with external lighting being carried on a surface of the LED candle includes: a LED candle body, the LED candle body includes a candle shell 1, a light source situated inside of the candle shell 1, a power supply electrically connected to the light source, an illuminant 2 carried on a surface of the candle shell 1, the illuminant 2 is electrically connected to the power source. The illuminant 2 is a string of lamps that wind the exterior surface of the candle shell 1 around. By a string of lamps winding the exterior surface of the candle shell 1 around, the entire candle from top to bottom is exposed to lighting, the LED candle has high brightness of lighting at night. Preferably, the string of lamps are composed by multiple LED lamp caps 21 in series connection. The LED lamp caps 21 may be set in the same color or colorful, the LED candle has good decoration effect.

In the embodiment of the present invention, the string of lamps form a rising helix structure to wind the exterior surface of the candle shell 1 around. A helix angle of the string of lamps is gradually increasing from down to up. More specifically, the helix angle is in the range of 45-60°. The LED candle has good decoration effect, as well as high economic value.

In the embodiment of the present invention, a helix groove carried on the exterior surface of the candle shell 1, the string of lamps is situated in the helix groove that has a fixation ability of the string of lamps to the groove, thus can protect the string of lamps and avoid damage to the string of lamps by anthropogenic collision, the service life of the string of lamps is prolonged. On the other hand, the helix groove has a hidden ability of the string of lamps, so as to improve the LED candle's aesthetic effect.

In the embodiment of the present invention, the power source is one of external power supplies, dry batteries and storage batteries. The candle shell 1 is Christmas tree-shaped in the embodiment. A factory can choose different power sources to satisfy the consumer's need for diversity. The LED candles have a wide application range.

### Embodiment 2

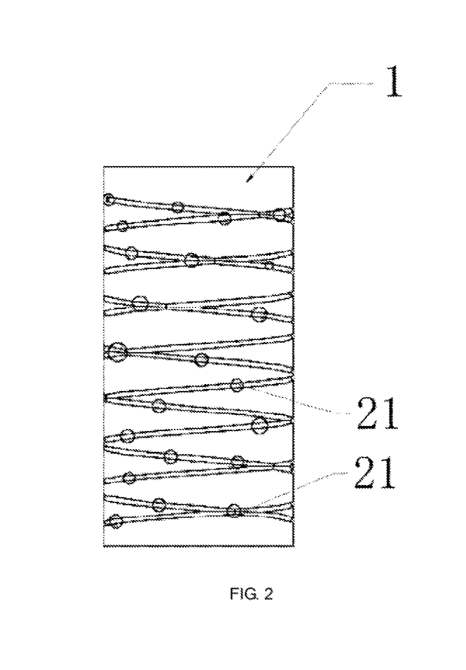

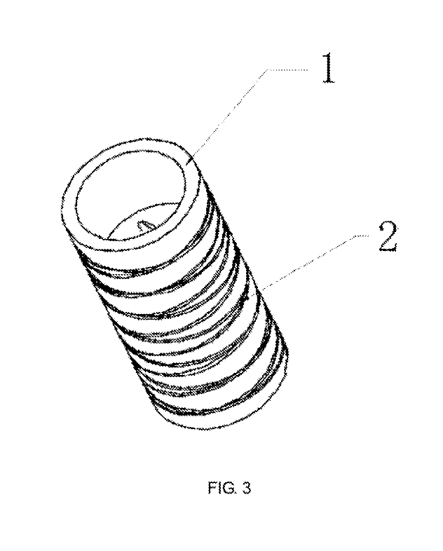

As shown in FIG. 2 and FIG. 3, the difference between the embodiment with embodiment 1 are as follows: exterior surface of the candle shell 1 has multiple holes, the illuminant 2 includes multiple LED lamp caps 21, each of the multiple holes is shaped and dimensioned to receive a LED lamp cap 21. The candle shell 1 is cylinder-shaped or columnar.

More specifically, multiple LED lamp caps 21 form a string of LED lamps. The LED lamp caps 21 are fixed to the multiple holes on the exterior surface of the candle shell 1. The mounting portion of the LED lamp cap 21 is connected to the power port inside of the LED candle. When a switch is powered on, the string of LED lamps emit light in synchrony with the light source, ensuring the brightness on the surface of the LED candle. The visibility at night is high.

In the embodiment, the hole is a dent, shape of the dent and that of a mounting portion of the LED lamp cap 21 are matched. The dent has a fixation ability of the LED lamp cap 21 to the dent, and has a proper hidden ability of the LED lamp cap 21, thus ensuring lighting effect and good decoration effect, without influencing the aesthetic effect.

The rest of the embodiment 2 is the same with the embodiment 1, will not be repeated here.

### Embodiment 3

The difference between the embodiment with embodiment 1 are as follows:

In the embodiment, the surface of the candle shell 1 has multiple through holes, each through hole is filled with a transparent material. The illuminant 2 includes multiple LED lamp caps 21 carried on the interior surface of the transparent materials.

By setting multiple through holes on the surface of the candle shell 1, filling each through hole with the transparent material and setting multiple LED lamp caps 21 inside of the candle shell 1, after powered on, not only inside of the LED candle has light, but also the light can pass through the transparent material to the surface of the LED candle, it looks like many extra LED lamps emit light. Preferably, multiple LED lamp caps 21 are in series connection on the power supply line.

In the embodiment, the transparent material is a paraffin layer or a transparent glass. Preferably, the paraffin layer or transparent glass has images, for weakening the empty as well as decorating the LED candles. The images may be determined as desired by the consumers, to satisfy people's different desires, and have a wide application range.

The rest of the embodiment is the same with embodiment 1, will not be repeated here.

### Embodiment 4

In the embodiment, the illuminants 2 are carried on the exterior surface and interior surface of the candle shell 1. The illuminants 2 carried on the exterior surface and interior surface of the candle shell 1 simultaneously ensure high bright ness of the candle shell 1 and high visibility at night.

In the embodiment, the candle shell 1 is Christmas tree-shaped, cylinder-shaped, spherical or columnar. A factory can choose different candle shells 1 to satisfy the consumer's need for diversity. The LED candles have a wide application range.

The rest of the embodiment is the same with the embodiment 1, will not be repeated here.

The foregoing descriptions are merely embodiments of the present invention, and are not intended to limit the scope of the present invention. An equivalent structural or equivalent process alternation made by using the content of the specification and drawings of the present invention, or an application of the content of the specification and drawings directly or indirectly to another related technical field, shall fall within the protection scope of the present invention.

I claim:

1. A LED candle with external lighting being carried on a surface of the LED candle, comprising:
a LED candle body;
the LED candle body has a candle shell;
a light source situated inside of the candle shell, a power supply electrically connected to the light source; and
an illuminant carried on a surface of the candle shell, the illuminant is electrically connected to the power source.

2. The LED candle with external lighting being carried on a surface of the LED candle of claim 1, wherein the illuminant is carried on an exterior surface and/or interior surface of the candle shell.

3. The LED candle with external lighting being carried on a surface of the LED candle of claim 1, wherein the illuminant is a string of lamps that wind the exterior surface of the candle shell around.

4. The LED candle with external lighting being carried on a surface of the LED candle of claim 3, wherein the string of lamps form a rising helix structure to wind the exterior surface of the candle shell around, a helix angle of the string of lamps is gradually increasing from down to up.

5. The LED candle with external lighting being carried on a surface of the LED candle of claim 1, wherein the surface of the candle shell has multiple holes, the illuminant has multiple LED lamp caps;
each of the multiple holes is shaped and dimensioned to receive a LED lamp cap.

6. The LED candle with external lighting being carried on a surface of the LED candle of claim 5, wherein the hole is a dent, shape of the dent and that of a mounting portion of the LED lamp cap are matched.

7. The LED candle with external lighting being carried on a surface of the LED candle of claim 1, wherein the surface of the candle shell has multiple through holes, each through hole is filled with a transparent material; the illuminant comprises multiple LED lamp caps carried on the interior surface of the transparent materials.

8. The LED candle with external lighting being carried on a surface of the LED candle of claim 7, wherein the transparent material is a paraffin layer or a transparent glass.

9. The LED candle with external lighting being carried on a surface of the LED candle of claim 1, wherein the power supply is an external power supply, a dry battery or a storage battery.

10. The LED candle with external lighting being carried on a surface of the LED candle of claim 1, wherein the candle shell is Christmas tree-shaped, cylinder-shaped, spherical or columnar.
